(19) United States
(12) Patent Application Publication
(10) Pub. No.: US 2026/0278370 A1
(43) Pub. Date: Sep. 17, 2026

(54) Systems and Methods for Efficient Differentiable Logic Gate Networks

(71) Applicant: DiffLogic Inc., Dover, DE (US)

(72) Inventor: Felix Petersen, Santa Clara, CA (US)

(73) Assignee: DiffLogic Inc., Dover, DE (US)

(21) Appl. No.: 19/659,956

(22) Filed: Apr. 27, 2026

Related U.S. Application Data
(63) Continuation of application No. PCT/US2026/019444, filed on Mar. 16, 2026.
(60) Provisional application No. 63/772,329, filed on Mar. 14, 2025.
(60) Provisional application No. 63/772,334, filed on Mar. 14, 2025.
(60) Provisional application No. 63/772,339, filed on Mar. 14, 2025.
(60) Provisional application No. 63/772,342, filed on Mar. 14, 2025.
(60) Provisional application No. 63/901,796, filed on Oct. 19, 2025.
(60) Provisional application No. 63/927,929, filed on Nov. 30, 2025.
(60) Provisional application No. 64/002,139, filed on Mar. 10, 2026.
(60) Provisional application No. 64/006,864, filed on Mar. 16, 2026.
(60) Provisional application No. 64/007,375, filed on Mar. 16, 2026.
(60) Provisional application No. 64/007,546, filed on Mar. 16, 2026.
(60) Provisional application No. 64/007,659, filed on Mar. 16, 2026.

(51) Int. Cl. G06N 3/08; G06F 1/03; G06N 3/042

(52) U.S. Cl. CPC G06N 3/08; G06F 1/03; G06N 3/042

(57) ABSTRACT

Systems and methods are disclosed for implementing and training differentiable logic-gate neural networks. A network includes hyper-logic gate nodes configured as differentiable lookup tables that receive selector signals and LUT entry signals and generate outputs via differentiable selection, enabling LUT-style multiplexing during discretization while remaining trainable by gradient-based optimization. LUT entry signals may be learned parameters, outputs of other nodes, external inputs, or internal memory-state values, enabling aggregation, switching, skip connections, and memory read/write operations. Training may employ constrained or reduced parameterizations that transform unconstrained trainable parameters via elementwise bounding functions and coefficient-mapping matrices to produce coefficient vectors for k-input gate functions, reducing storage and computation relative to enumerating discrete gates. Mixed-precision training may compute forward activations at lower precision while performing backpropagation at higher precision with selective storage or recomputation.

### RELATED APPLICATIONS

This application is a continuation of PCT Patent Application No. PCT/US2026/019444, filed on Mar. 16, 2026, titled “Systems and Methods for Efficient Differentiable Logic Gate Networks” (DFL0430), which claims priority to U.S. Provisional Patent Application No. 63/772,329, filed on Mar. 14, 2025, titled “Extended Differentiable Logic Gate Networks” (DFL0100); U.S. Provisional Patent Application No. 64/002,139, filed on Mar. 10, 2026, titled “Logic Gate Network Systems, Methods, and Devices” (DFL0101); U.S. Provisional Patent Application No. 63/772,334, filed on Mar. 14, 2025, titled “Method for Construction and Synthesis of Efficient Feature Extractors” (DFL0300); U.S. Provisional Patent Application No. 64/006,864, filed on Mar. 16, 2026, titled “Systems and Methods for Construction and Implementation of Efficient Feature Extractors” (DFL0301); U.S. Provisional Patent Application No. 63/772,339, filed on Mar. 14, 2025, titled “Efficiency Improvements for Training Differentiable Logic Gate Networks” (DFL0400); U.S. Provisional Patent Application No. 64/007,659, filed on Mar. 16, 2026, titled “Systems and Methods for Efficient Differentiable Logic Gate Networks” (DFL0401); U.S. Provisional Patent Application No. 63/772,342, filed on Mar. 14, 2025, titled “Data-based and Stochastic Logic Simplification of Logic Gate Networks” (DFL0600); U.S. Provisional Patent Application No. 64/007,375, filed on Mar. 16, 2026, titled “Data-Based, Ranking-Guided, and Stochastic Approximate Logic Optimization of Logic Gate Networks” (DFL0603); U.S. Provisional Patent Application No. 63/901,796, filed on Oct. 19, 2025, titled “Digital Neural Inference Integrated Circuit with Predominantly Latent Parameterization Circuitry” (DFL0900); U.S. Provisional Patent Application No. 63/927,929, filed on Nov. 30, 2025, titled “Training Apparatus with Integrated Circuits for Training Logic Gate Networks” (DFL1000); and U.S. Provisional Patent Application No. 64/007,546, filed on Mar. 16, 2026, titled “Neural Network Application-Specific Integrated Circuit” (DFL1200), each of which is hereby incorporated by reference in its entirety.

Various embodiments of this application also relate to, can be further understood in the context of, and/or can be combined with embodiments described in U.S. patent application Ser. No. 19/301,717, filed on Aug. 15, 2025, titled “Logic Gate Networks Generated Using Differentiable Logic Gate Models” (DFL0800); and U.S. patent application Ser. No. 19/392,098, filed on Nov. 17, 2025, titled “Digital Neural Inference Integrated Circuits with Predominantly Latent Parameterization Circuitry” (DFL0920), each of which is hereby incorporated by reference in its entirety.

### TECHNICAL FIELD

This disclosure relates to artificial intelligence (AI), machine learning, and logic gate networks. More specifically, this disclosure relates to implementing and training differentiable-logic-gate neural networks, including networks comprising differentiable lookup table (LUT) nodes, and to training techniques that reduce computational cost, memory usage, and/or bandwidth during training.

### BRIEF DESCRIPTION OF THE DRAWINGS

FIG. 1 illustrates an example logic gate neural network configured to process an image input and produce a classification output, according to one embodiment.

FIG. 2A illustrates an example table enumerating two-input logic operators, corresponding real-valued relaxation formulations, and truth tables, according to one embodiment.

FIG. 2B illustrates an example table of t-norm formulations usable as differentiable relaxations of logical AND, according to one embodiment.

FIG. 2C illustrates an example table of t-conorm formulations usable as differentiable relaxations of logical OR, according to one embodiment.

FIG. 3A illustrates an example computation pipeline that maps a trainable parameter vector to a probability distribution and to coefficients for computing a differentiable logic gate output, according to one embodiment.

FIG. 3B illustrates an example computation pipeline that maps a trainable parameter vector to bounded pre-coefficients and to coefficients via a coefficient-mapping matrix, according to one embodiment.

FIG. 4 illustrates an example hyper-logic gate configured as a differentiable lookup table, according to one embodiment.

FIG. 5A illustrates an example process for computing coefficients for at least one node of a differentiable-logic-gate neural network using constrained parameterization, according to one embodiment.

FIG. 5B illustrates an example process for training a differentiable logic gate network and for discretizing the trained network, according to one embodiment.

FIG. 6A illustrates an example process for training a differentiable-logic-gate neural network, according to one embodiment.

FIG. 6B illustrates an example process for training a logic gate neural network and generating a fixed logic gate network, according to one embodiment.

FIG. 7 illustrates an example mixed-precision training process that performs forward propagation, stores activation values using a first numeric precision and performs backpropagation using a second numeric precision higher than the first numeric precision, according to one embodiment.

FIG. 8 illustrates an example computing system architecture for implementing, training, and/or discretizing a logic gate neural network including one or more hyper-logic gate nodes, lookup-table type nodes, and/or switch-logic gate nodes, according to various embodiments.

FIG. 9 illustrates an example aggregation of node outputs for use by a subsequent node or layer, according to one embodiment.

FIG. 10 illustrates an example convolutional logic gate network architecture, according to one embodiment.

FIG. 11 illustrates an example hardware placement of a trained logic gate network on a programmable logic device, according to one embodiment.

### DETAILED DESCRIPTION

Logic gate networks (LGNs), also known as logical or binary circuits, represent computations as networks of interconnected logic gate nodes (e.g., AND, OR, XOR, NAND). Such networks can be advantageous for deployment on digital hardware, including programmable logic devices, because the resulting inference computation can be expressed as a collection of Boolean and/or bitwise operations and/or lookups in lookup tables (LUTs).

Training a logic gate network by selecting, for each node, a specific discrete gate operator or LUT configuration is generally a combinatorial optimization problem. Differentiable relaxations of logic gate operators and/or differentiable parameterizations of gate-selection and LUT-selection allow end-to-end gradient-based optimization; however, conventional differentiable training techniques can still incur significant overhead. For example, some approaches represent each node as a soft selection among a set of candidate discrete gate operators using a softmax distribution over many trainable parameters, which can increase memory usage and compute cost, particularly for k-input functions with large candidate sets.

Accordingly, there is a need for improved architectures and training techniques for differentiable logic gate neural networks, including (i) more expressive trainable nodes that can implement LUT-style selection while remaining differentiable for training, (ii) constrained parameterizations that reduce the number of trainable parameters and/or avoid normalization overhead while maintaining validity constraints for real-valued gate relaxations, and (iii) training architectures that reduce memory-bandwidth requirements by using asymmetric numeric precision and/or selective storage and recomputation during backpropagation.

Systems and methods are disclosed for implementing and training differentiable-logic-gate neural networks. In some embodiments, a logic gate neural network includes one or more hyper-logic gate nodes configured as differentiable lookup tables (LUTs). A hyper-logic gate receives selector signals and LUT entry signals and produces an output by performing a differentiable selection among the LUT entry signals as a function of the selector signals. The differentiable selection enables gradient-based training in a differentiable mode and can implement LUT selection (e.g., multiplexing) in a discretized mode when selector signals are binary-valued.

In some embodiments, training employs constrained parameterizations for differentiable gate functions. A trainable parameter vector in an unconstrained domain is transformed by an element-wise non-linear bounding function to obtain bounded parameters, and a coefficient-mapping matrix is applied to obtain a coefficient vector that parameterizes a differentiable k-input node function and satisfies one or more predetermined validity constraints. Such parameterizations can reduce training and/or inference computation relative to enumerating a large set of candidate discrete operators.

In some embodiments, training is performed using mixed-precision techniques. For example, a forward propagation through a differentiable logic gate neural network may be performed using a first numeric precision, activation values may be stored in a second numeric precision, while backpropagation may be performed using a third numeric precision higher than the first numeric precision and/or higher than the second numeric precision, including converting stored values to the higher precision and/or recomputing intermediate values from stored values.

Various embodiments are described below with reference to the accompanying drawings. In the drawings, similar reference numerals may indicate similar elements. The embodiments described herein are illustrative and are not intended to limit the scope of the disclosure. In particular, the described techniques may be applied to a variety of logic gate network architectures, training objectives, and deployment targets.

As used herein, a “logic gate neural network” (also referred to as a “logic gate network”) includes a plurality of interconnected nodes configured to receive at least one network input and produce at least one network output. Each node may be configured to compute a logic-gate-like function (e.g., AND, OR, XOR, NAND) and/or a lookup-table (LUT) function, or a differentiable relaxation thereof. For example, a set of potential logic gate operators may include any combination of an AND operator, an OR operator, a NAND operator, a NOR operator, an XOR operator, a negated implication operator, a constant TRUE operator, a constant FALSE operator, an inverter operator, an entry of a lookup table (e.g., a lookup-table-defined operator, such as a FALSE operator 0000, an AND operator 0001, a negated implication operator 0010, a pass-through wire “A” operator 0011 and the like), and a pass-through operator that outputs one of the node inputs. The previous enumeration may include identical elements using different names. By way of a non-limiting example, a four-input “AND of Ors” logic gate operator may also be referred to as a lookup table entry 0000′0111′0111′0111, a logic gate operator with ID 1911, or in a hexadecimal representation 0x0777, which may be one of 65536 possible 4-input logic gate operators. Non-limiting examples of node types include (i) differentiable logic-gate nodes parameterized by coefficient vectors for k-input node functions and/or (ii) hyper-logic gate nodes configured as differentiable LUTs that perform differentiable selection among LUT entry signals as a function of selector signals. Nodes may be arranged in layers and/or connected in other graph structures, including directed acyclic graphs and graphs with recurrence and/or internal memory state. In some embodiments, the logic gate neural network is configured for tasks such as, by way of non-limiting example, classification, regression, reinforcement learning control, clustering, anomaly detection, language modeling, generative artificial intelligence, time-series prediction and forecasting, encoding, decoding, and/or signal processing, and may be trained in a differentiable mode and thereafter discretized to produce a fixed-logic gate network for inference and/or hardware implementation.

In various embodiments, the disclosed systems and methods may also be used for logic synthesis tasks, including exact or approximate synthesis, simplification, restructuring, and/or optimization of a logic circuit corresponding to exactly executing a prespecified function or approximating a predefined function. In various embodiments, a logic circuit may comprise combinational logic, sequential logic, or both. By way of example and without limitation, a logic circuit may include logic gates, inverters, multiplexers, lookup tables, adders, counters, flip-flops, latches, registers, delay elements, shift registers, SRAM cells, and/or other state-holding circuit elements. In various embodiments, the disclosed techniques may be applied to combinational, sequential, and/or mixed combinational/sequential portions of such logic circuits. In sequential embodiments, an input may include one or more input values together with an initial, current, prior, or reset state of the logic circuit, and may, in some embodiments, comprise a temporal sequence of inputs and/or states.

In some embodiments, the methods described herein may be used without performing a discretization step. For example, in some implementations, the differentiable logic gate network may be retained in its differentiable form and used directly for inference, analysis, or deployment. Such embodiments may be advantageous in contexts including, but not limited to, explainable artificial intelligence, interpretability analysis, probabilistic modeling, and probabilistic circuits. In such embodiments, the differentiable node representations, including multilinear polynomial representations and associated differentiable coefficients, may provide interpretable or probabilistic semantics, such as representing weighted logical relationships, soft truth assignments, or probability-like measures. As such, discretization to a fixed set of logic gate operators may be performed in some embodiments to obtain a hardware-efficient implementation; however, in some embodiments, the differentiable representations described herein may be used independently of discretization.

In some embodiments, the plurality of input signals to a hyper-logic gate may be partitioned into selector signals and LUT entry signals, where the selector signals control selection among the LUT entry signals. In various embodiments, the selector signals may correspond to data inputs of the hyper-logic gate, and the LUT entry signals may correspond to configuration inputs. In some embodiments, one or more signals may serve dual roles, such that a signal used as a data input in one context may serve as a selector signal in another context, and/or a signal used as a configuration input in one context may serve as a LUT entry signal in another context.

In some embodiments, values propagated through a logic-gate neural network represent truth values and are bounded within a range, such as [0,1] (or, in some embodiments, [−1,1] or another bounded range). For example, 0 may represent “false,” and 1 may represent “true,” while values between 0 and 1 may represent probabilities, fuzzy values, or other real-valued relaxations. In some embodiments, one or more signals are maintained in an unconstrained domain (e.g., logits or real values) and are mapped to the bounded range using one or more bounding functions for purposes of gate evaluation. In a discretized mode, one or more signals and/or node outputs may be binarized (e.g., to 0 or 1), and one or more nodes may be replaced with corresponding hard (non-differentiable) Boolean operators and/or hard LUT selection. In some embodiments, discretization and/or quantization may instead (or additionally) produce multi-bit values (e.g., 2-bit, 4-bit, 8-bit) for fixed-point or integer inference.

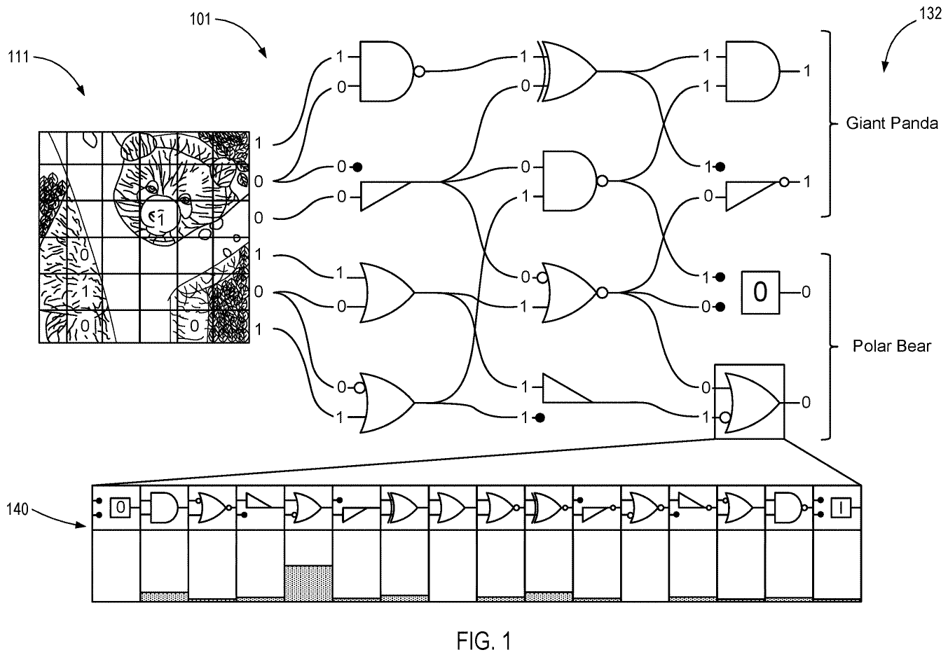

FIG. 1 illustrates an example randomly connected logic-gate network architecture 101. In the illustrated embodiment, an input representation 111 (e.g., a binarized or discretized input patch corresponding to a portion of an image or other structured input) provides input values to a plurality of interconnected logic-gate nodes of the architecture 101. The nodes are connected in a non-convolutional, non-parameter-shared manner (i.e., with connectivity that is not constrained to local receptive fields or structured weight sharing), and the resulting network produces one or more outputs 132, which in the illustrated example correspond to classification outputs (e.g., a “Giant Panda” output and a “Polar Bear” output). In some embodiments, each node of the architecture 101 is represented as a selectable logic gate chosen from an available set of logic gate choices 140, and during training, the node's selected operation (or a trainable representation thereof) is learned (e.g., by learning gate-choice distributions and/or other trainable parameters that are later discretized into fixed per-node gate selections).

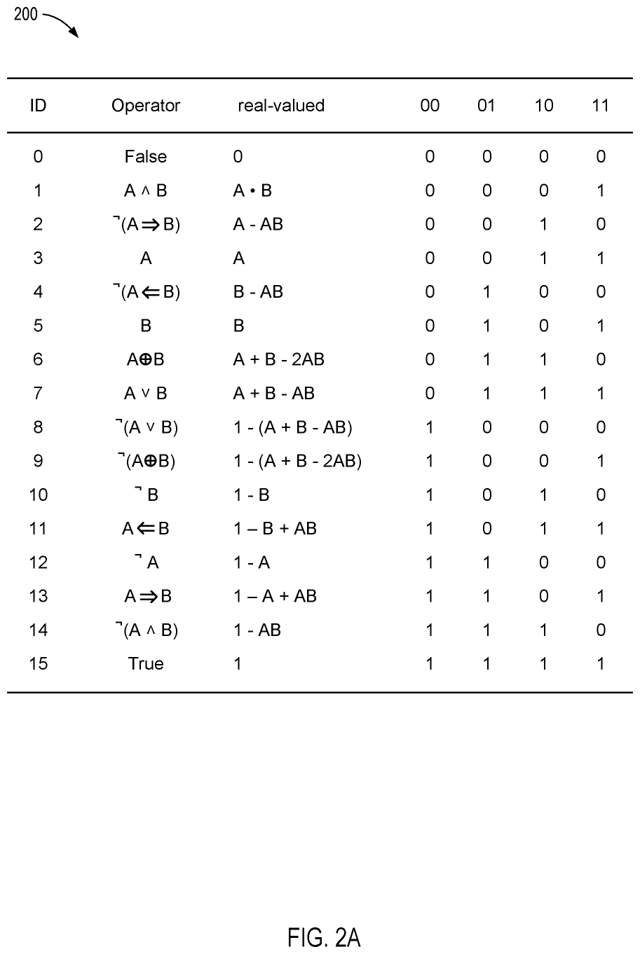

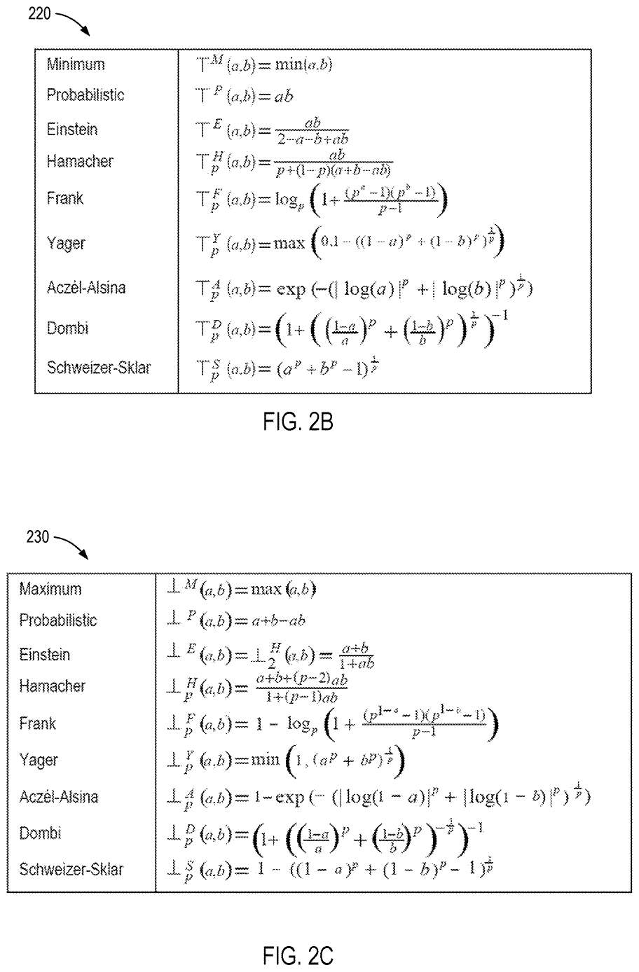

FIG. 2A illustrates a table 200 with an example operator set for a two-input differentiable logic gate node, enumerating a plurality of candidate logic gate operators (e.g., sixteen operators corresponding to the sixteen possible Boolean functions of two inputs). In the illustrated embodiment, the table 200 includes (i) an identifier (ID) for each operator, (ii) an operator name and/or Boolean form, (iii) a corresponding real-valued (continuous) relaxation formula, and (iv) a truth table indication (e.g., outputs for inputs 00, 01, 10, and 11). In some embodiments, the “real-valued” formulas correspond to probabilistic or fuzzy-logic relaxations in which node input activations A and B are treated as real values (e.g., probabilities) in [0,1], thereby enabling differentiability during training.

In some embodiments, the two-input candidate operators of FIG. 2A are represented in the discretized form as lookup-table (LUT) entries (truth tables) and/or as compact integer identifiers. For example, in a two-input case with inputs A and B, the truth table may be ordered as input patterns (A, B)=00, 01, 10, 11, yielding outputs (t00, t01, t10, t11). In one implementation, an operator identifier ID in the range 0-15 is computed as: ID=8·t00 +4·t01+2·t10+t11. In such embodiments, storing the selected operator for a node may include storing the ID and/or storing the corresponding 4-bit truth-table vector, and evaluating the node in the discretized network may include using the ID as a LUT index.

Under the above encoding, the single-input residual operators (i.e., operators that depend on only one input) correspond to the following IDs: NOT A has truth table (1,1,0,0) and ID=12; NOT B has truth table (1,0,1,0) and ID=10; B has truth table (0,1,0,1) and ID=5; and A has truth table (0,0,1,1) and ID=3. Accordingly, in certain embodiments, residual initialization comprises biasing the initial trainable parameters so that, prior to training, a disproportionate fraction of two-input nodes would be discretized to one of IDs 3, 5, 10, or 12 (e.g., ID=3 to implement a “wire A” pass-through), while training may subsequently cause at least some nodes to transition to other IDs that functionally depend on both inputs.

As described herein, a node may be configured to compute an output using a differentiable operator that relaxes a discrete Boolean function to operate on real-valued inputs. For example, a probabilistic relaxation of logical conjunction (AND) may be implemented as multiplication (A·B), and a probabilistic relaxation of exclusive OR (XOR) may be implemented as A+B−2AB. Other relaxations may also be used.

FIG. 2B illustrates an example table 220 of exemplary families of T-norm (triangular norm) functions that may be used as differentiable, real-valued implementations of conjunction (logical “AND”) in a differentiable logic gate network, including implementations that operate on relaxed activations (e.g., probabilistic activations) in a continuous range such as [0,1]. In some embodiments, T-norms and T-conorms serve as building blocks of real-valued logics and may be used as alternatives to probabilistic T-norm/T-conorm implementations elsewhere in the disclosure.

FIG. 2C illustrates a table 230 of exemplary families of T-conorm (triangular conorm) functions that may be used as differentiable, real-valued implementations of disjunction (logical “OR”) in a differentiable logic gate network, including implementations that operate on relaxed activations in a continuous range, such as [0,1].

In some embodiments, a differentiable logic-gate node is parameterized as a differentiable k-input node function having a coefficient vector. For example, a node output may be computed as an evaluation of a multilinear polynomial over k node-input values using 2\hat{ }k coefficients. In some embodiments, the coefficients correspond to (or are derived from) 2\hat{ }k LUT entry values associated with respective binary input patterns, such that the node function interpolates between LUT entries in a differentiable mode and recovers a truth-table/LUT evaluation when inputs are discretized. In some embodiments, the coefficients (or LUT entry values) may be stored as bounded values (e.g., within [0,1]) and may be mapped to another coefficient basis via a predetermined linear transform (e.g., a coefficient-mapping matrix or a coefficient-mapping matrix implementing a Möbius transform, Walsh-Fourier transform, or other multilinear basis change). Such formulations can represent a broad class of k-input Boolean functions (and relaxations thereof) while enabling efficient evaluation using a coefficient vector smaller than a distribution over a large set of candidate discrete operators. In some embodiments, parameters may be real-valued in an unbounded range, and optionally mapped via a predetermined linear transform (e.g., a coefficient-mapping matrix or a coefficient-mapping matrix implementing a Möbius transform, Walsh-Fourier transform, or other multilinear basis change) to coefficient values. In some embodiments, an element-wise non-linear bounding transformation may be used.

In some embodiments, during training, a node configurable to implement a discrete operation in a discretized (deployment) form is represented as a trainable form that combines the outputs of multiple candidate operations in a differentiable manner. For example, a two-input node receiving inputs and (which may be real-valued relaxations in [0,1] during training) may be associated with candidate operations (e.g., candidate logic gate operators, candidate node functions, or candidate lookup-table entries, as described in detail herein), and a parameter vector (e.g., unnormalized scores, logits, etc.) that is mapped to coefficients or selection weights used to combine the outputs of the candidates.

In some embodiments, the relaxed computation of a node comprises computing a multilinear polynomial, by way of non-limiting example, w0+x0*w1+x1*w2+x0*x1*w3, wherein x0, x1 are node inputs and w0, w1, w2, w3 are coefficients based on differentiable parameters.

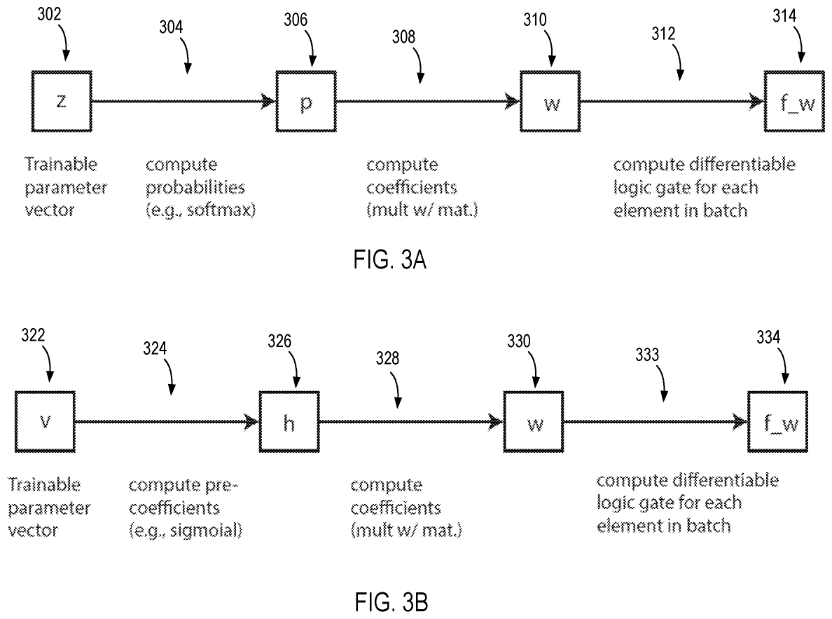

FIG. 3A illustrates an example computation pipeline in which, in some embodiments, a trainable parameter vector z 302 is mapped, in an operation 304, to a probability distribution p 306 over a set of candidate discrete gate operators (e.g., via a softmax), and a coefficient vector w 310 is then computed (e.g., in an operation 308 by multiplying by a coefficient-mapping matrix) for use in evaluating a node function output f_{w} 314. In some embodiments, evaluating the node function output f_{w} 314 includes computing, in an operation 312, a differentiable logic gate output for each element in a batch. In some embodiments, the coefficient-mapping matrix is predetermined (e.g., fixed) and maps from probabilities associated with candidate gate operators to coefficients for an equivalent polynomial or other algebraic representation.

FIG. 3B illustrates an example constrained-parameterization pipeline in which a trainable parameter vector v 322 is transformed, in an operation 324, to an optionally bounded parameter vector h 326 (also referred to herein as a pre-coefficient vector) using a function (e.g., an elementwise non-linear bounding function). The optionally bounded parameter vector h 326 is then mapped, in an operation 328, to coefficients w 330 using a coefficient-mapping matrix, and a differentiable node function f_{w} 334 is evaluated. In some embodiments, evaluating the differentiable node function f_{w} 334 includes computing, in an operation 333, a differentiable logic gate output for each element in a batch. In some embodiments, this is more efficient because the operation applied to many elements of a batch are fewer. In some embodiments, the elementwise non-linear bounding function of operation 324 maps from an unconstrained domain (e.g., real numbers) to a bounded range (e.g., [0,1]). Example bounding functions include logistic functions, cumulative distribution functions (CDFs) (e.g., Gaussian CDF), other sigmoidal functions, and/or other non-sigmoidal bounding functions.

In some embodiments, the system may use a coefficient-mapping matrix M such that, for any bounded parameter vector h within the bounded range, the resulting coefficient vector w=M·h satisfies one or more predetermined validity constraints. For example, a validity constraint may constrain a differentiable node function to map node-input values in [0,1] to node outputs within [0,1]. Additional non-limiting examples of validity constraints include enforcing boundary conditions at Boolean corners, monotonicity with respect to one or more inputs, symmetry with respect to input permutation, De Morgan duality, and/or other constraints selected for a particular operator family or application. In one example for a two-input node function (k=2), a 4×4 coefficient-mapping matrix may map bounded parameters h∈[0,1]∝to coefficients w∈R\hat{ }4 in a manner that ensures the resulting function f_{w} remains within [0,1] for inputs in [0,1]. In some embodiments, the coefficient-mapping matrix is an identity matrix (or is omitted), such that the bounded parameter vector h is used directly as the coefficient vector w. In some embodiments, the bounded parameter vector h need not sum to 1 (e.g., no probability normalization is required), thereby, in some embodiments, reducing computational and/or memory-bandwidth requirements relative to probability-normalized gate-selection approaches. In some embodiments, the system may use a coefficient-mapping matrix M without the need of any bounded parameter vector, and/or wherein the resulting coefficient vector w=M·h may be unconstrained. In some of such embodiments, the node output may, e.g., after a multilinear polynomial, utilize a bounding function to satisfy one or more constraints. In some embodiments, there may not be any bounding functions and/or no range constraints in some of the nodes. For example, values across the full range of real values may be used to represent logits corresponding to respective activation probabilities, thereby, in some embodiments, in a respective representation requiring no boundary constraints on the activations.

In some embodiments, a logic gate neural network includes one or more nodes configured as a hyper-logic gate. A hyper-logic gate is a differentiable computational element that implements (or approximates) selection from among a plurality of LUT entry signals based on a plurality of selector signals and may be understood as a differentiable lookup table (LUT), a differentiable multiplexer, and/or a differentiable switching element. In some embodiments, the hyper-logic gate receives k selector signals and 2\hat{ }k LUT entry signals, where k≥1, and produces a hyper-logic gate output that is a differentiable function of the selector signals and the LUT entry signals. In a differentiable mode, the hyper-logic gate performs a differentiable selection, enabling gradient-based training. In a discretized mode, the hyper-logic gate can implement LUT selection (e.g., a multiplexer) so that the output corresponds to the selected LUT entry, identified by binary-valued selector signals. In various embodiments, the selector signals and/or LUT entry signals comprise signals provided by learned parameters, outputs of other nodes, network inputs, and/or values from one or more internal memory states. In various embodiments, internal memory states refer to a flip-flop, latch, SRAM, or similar element that provides information produced one or more cycles ago.

In some embodiments, a differentiable or continuous k-input lookup table receives k data inputs and N configuration inputs, where N is any integer greater than k. In many embodiments, N=2\hat{ }k such that each binary pattern of the k data inputs corresponds to a respective configuration input; in other embodiments, N may be approximately 2\hat{ }k, may have the same order of magnitude as 2\hat{ }k, and/or may be greater than 2\hat{ }k, for example where one or more configuration inputs are unused, duplicated, shared among multiple patterns, or selected via a mapping from the 2\hat{ }k binary patterns to the N configuration inputs. In some embodiments, the differentiable or continuous k-input lookup table serves as a continuous relaxation of a discrete k-input lookup table, and training propagates gradients, approximate gradients, sub-gradients, gradient estimates, and/or surrogate gradients through the continuous selection. In some other embodiments, a differentiable k-input lookup table may be stochastically relaxed, for example, using gradient estimate based backpropagation.

In some embodiments, the elementwise non-linear bounding function may comprise any suitable non-linear mapping (whether sigmoidal or non-sigmoidal) that maps an unconstrained value (e.g., a real-valued trainable parameter) to a bounded range (e.g., [0,1] or [−1,1]). Non-limiting examples include a hyperbolic tangent function, a hard-sigmoid function (e.g., a piecewise-linear approximation to a logistic sigmoid), and a piecewise-linear saturating function. In various embodiments, the bounding function may additionally include scaling, shifting, temperature adjustment, and/or clipping operations, and may be differentiable, differentiable almost everywhere, or paired with a sub-gradient or surrogate-gradient rule for training. In some embodiments, a non-linear bounding function may be stochastic and may utilize stochastic gradient estimation during backpropagation.

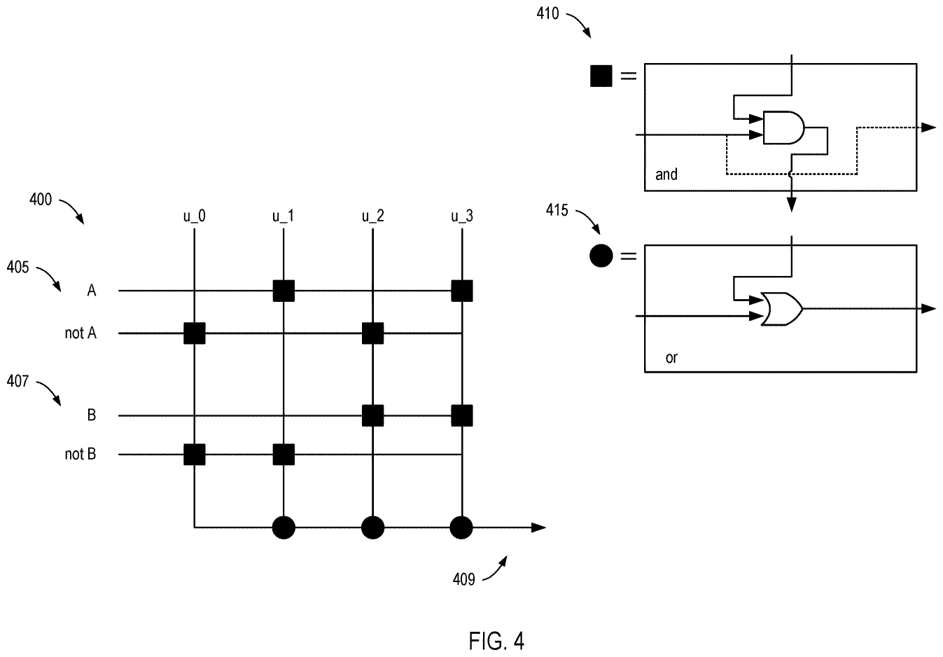

FIG. 4 illustrates an example two-input lookup-table structure 400 that may be used as a hyper-logic gate. In the illustrated example, a first selector signal A (and, in some embodiments, its inversion ¬A) is provided via selector input lines 405, and a second selector signal B (and, in some embodiments, its inversion ¬B) is provided via selector input lines 407, either of which may be provided, for example, by learnable parameters, node outputs, external inputs, and/or internal memory-state values. LUT entry signals u_0, u_1, u_2, and u_3 may be provided (e.g., by learnable parameters, node outputs, external inputs, and/or internal memory-state values) and combined with the selector signals to produce a hyper-logic gate output 409. In some embodiments, the lookup-table structure 400 may be understood as a network of elementary operators, such as AND elements 410 and OR elements 415.

More generally, in some embodiments, a hyper-logic gate receives k selector signals and 2\hat{ }k LUT entry signals. Each LUT entry signal may be associated with a respective selector pattern of the k selector signals (e.g., a bitstring in {0,1}\hat{ }k). For each selector pattern, the hyper-logic gate computes a corresponding differentiable selection weight as a differentiable function of the selector signals. In some embodiments, computing the differentiable selection weight includes combining the selector signals (and/or inversions of the selector signals) using at least one differentiable conjunction operator, such as a product t-norm or another t-norm. For example, for a selector pattern b=(b1, . . . , bk), a corresponding selection weight may be computed by forming k terms ti, where ti=Si when bi=1 and ti=(1−Si) when bi=0, and then combining the k terms using a differentiable conjunction operator.

For each selector pattern, the hyper-logic gate combines the corresponding differentiable selection weight with the associated LUT entry signal to produce a combined value. In some embodiments, combining includes multiplying the selection weight and the LUT entry signal, or applying another differentiable operator. The hyper-logic gate aggregates the combined values across selector patterns to produce a hyper-logic gate output. In some embodiments, aggregating comprises at least one of summation, a differentiable disjunction operator, and a t-conorm. For example, in probabilistic logic, a disjunction may be implemented as x+y−xy; however, when selection weights correspond to mutually exclusive selector patterns (e.g., due to using a selector signal and its inversion), aggregation by summation may be used and may provide computational and/or numerical advantages. In some embodiments, a selection weight may not correspond to an arithmetic weight, for example, in a minimum t-norm/maximum t-conorm relaxation.

In a discretized mode, selector signals may be binary-valued. In such a mode, the differentiable conjunction and disjunction operators may reduce to discrete logic operations, and the differentiable selection weights may be one-hot (i.e., one selection weight equal to 1 and the others equal to 0), such that the hyper-logic gate output corresponds to a single LUT entry signal. In some embodiments, discretization is performed after training and includes binarizing selector signals and/or selecting discrete operator instances for one or more nodes.

In some embodiments, one or more of the LUT entry signals of a hyper-logic gate are provided by learnable parameters stored in memory. Such parameters may be stored using real-valued data types and may be constrained to a bounded range (e.g., [0,1]) using one or more transformations (e.g., a sigmoid or another bounding function). In some embodiments, one or more LUT entry signals are provided by outputs of other nodes in the logic gate neural network. In some embodiments, one or more LUT entry signals are provided by network inputs. In some embodiments, one or more LUT entry signals are provided by an internal memory state, such as content stored in a register, flip-flop, latch, buffer, or random-access memory.

In some embodiments, for k=2, a single hyper-logic gate may compute eight selector-pattern values using at least eight applications of a t-norm and aggregate corresponding combined values using multiple t-conorm operations. For instance, the three t-conorm operations may be arranged as an aggregation tree. In some embodiments, all 2\hat{ }k configuration inputs to a hyper-logic gate (or approximately 2\hat{ }k configuration inputs), all k data inputs to the hyper-logic gate, or both, may be provided by values stored in registers and/or flip-flops and/or by outputs of other computational nodes. Accordingly, the hyper-logic gate may have no trainable parameters, and all k+2\hat{ }k inputs may be dynamic signals. In some embodiments, a computational node of the network may comprise a memory element that stores a state value and provides the state value as an output to one or more other computational nodes. In some embodiments, a single hyper-logic gate may employ different and/or distinct differentiable relaxations for different logical operations within its computation. Moreover, different hyper-logic gates within the same network may employ different relaxation families from one another.

In some embodiments, the logic gate neural network includes an internal memory state comprising a plurality of memory locations. A hyper-logic gate may be configured to access a selected memory location as a function of its selector signals and to produce the hyper-logic gate output based at least in part on content stored in the selected memory location. For example, the selector signals may represent an address, and the memory content may be provided as the LUT entry signals. In some embodiments, a hyper-logic gate is configured to write to a memory location as a function of selector signals by updating content stored in the memory location based at least in part on (i) the hyper-logic gate output and (ii) the current content of the memory location.

As another example, a node may be configured as a switch-logic gate or differentiable k-selector input switch. In some embodiments, the switch-logic gate receives k selector inputs and one data input and produces a plurality of outputs at a plurality of output locations corresponding to respective selector patterns of the k selector inputs. For each output location, a respective differentiable selection weight and/or update degree may be computed by combining either a selector input or one minus the selector input for each of the k selector inputs, according to the corresponding selector pattern. In such embodiments, the respective differentiable selection weight and/or update degree may be combined with the data input to generate the output for that output location. In some embodiments, switch-logic gate writes to a specified memory state location. In other embodiments, it overwrites a respective wire out of a number (e.g., 2\hat{ }k) of wires. In still other embodiments, it may write to a respective memory state location for some selector inputs and overwrite wires for some other selector inputs, depending on the specified selector input. In some embodiments, the selector inputs specify a memory-location index of a state memory having 2\hat{ }k memory locations. Data input may be written to the indexed memory location. For example, data may be written to the indexed memory location as a function of the current content of the indexed memory location. In some embodiments, the state memory may be implemented using registers and/or flip-flops. To update a respective location, a selector weight and/or update degree may be utilized, and in a differentiable mode, may correspondingly use, for example, a relaxation of (B AND C) OR (A AND NOT C), wherein A is the previous activation or memory value, B is the selector weight and/or update degree, and C is the data input. In some embodiments, this may be relaxed to C*B+(1−C)*A.

In some embodiments, a hyper-logic gate is used to implement a skip connection. For example, the hyper-logic gate may receive, as at least one LUT entry signal, an output of a node that is not in an immediately preceding layer of the logic gate neural network, and may select or combine LUT entry signals such that the hyper-logic gate output provides information from the non-adjacent node.

In some embodiments, a hyper-logic gate is used to aggregate the outputs of one or more previous layers into fewer elements. For example, the hyper-logic gate may receive, as input signals, node outputs from a prior layer and may be configured to select, combine, and/or pool those node outputs to produce a reduced-dimensionality output for a subsequent layer.

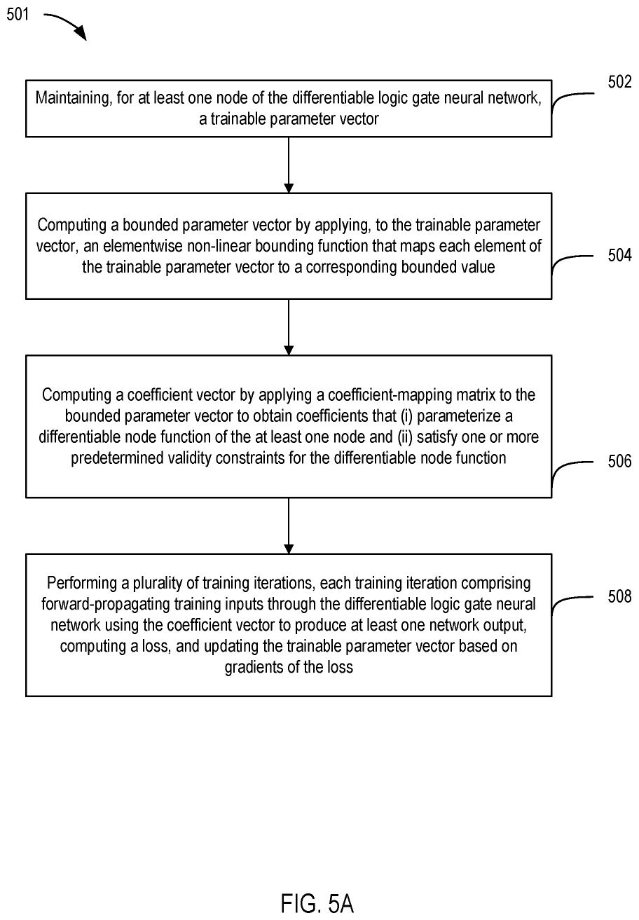

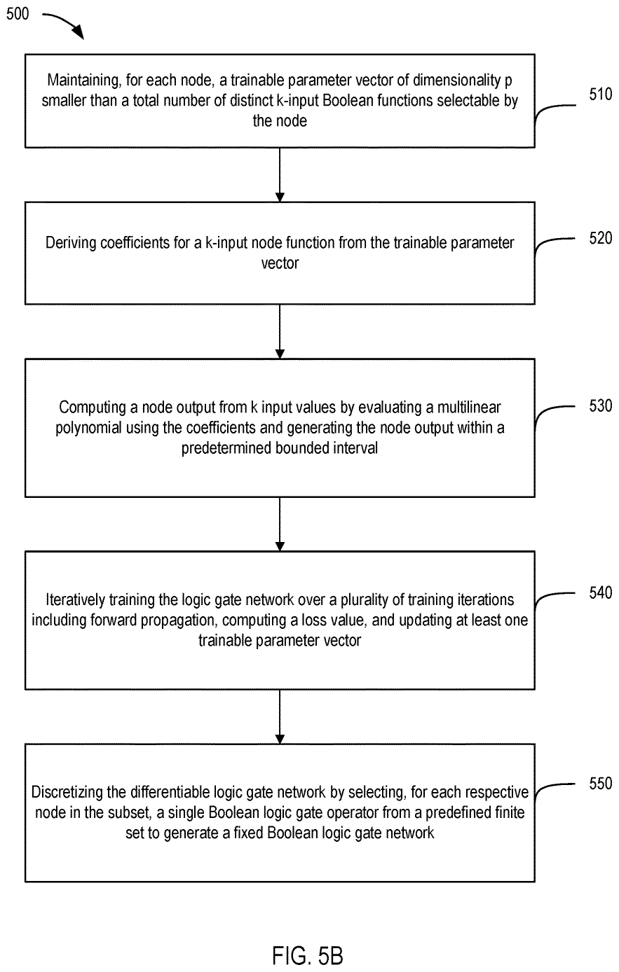

FIG. 5A illustrates an example process 501 for training using constrained parameterization. In some embodiments, process 501 includes maintaining a trainable parameter vector (step 502), computing a bounded parameter vector using an element-wise non-linear bounding function (step 504), computing a coefficient vector using a coefficient-mapping matrix (step 506), and computing a differentiable node output through a plurality of training iterations (step 508). The computed node output may be used during forward and backward propagation during training iterations.

In some embodiments, the use of coefficient vectors and coefficient-mapping matrices enables a reduction in computation and/or storage relative to representing a node as a soft selection among an exponentially large set of candidate discrete operators. For example, for k=2, a soft selection among 16 candidate two-input logic operators may be represented using a 16-element parameter vector, while a multilinear-polynomial representation may be evaluated using 2\hat{ }k=4 coefficients. Similarly, for k=3, a representation based on probabilities over 256 candidate truth tables may be reduced to 2\hat{ }k=8 coefficients for multilinear evaluation. In some embodiments, the computing system trains a logic gate neural network by directly optimizing O(2\hat{ }k) parameters per node, rather than optimizing parameters associated with enumerating a large set of candidate discrete operators.

In some embodiments, for a k-input Boolean node, the total number of distinct k-input Boolean functions is 2\hat{ }(2\hat{ }k). A trainable parameter vector used to parameterize such a node may have dimensionality p that is smaller than the total number of distinct k-input Boolean functions, smaller than half of that total, or equal to 2\hat{ }k. In some embodiments, random noise may be introduced into the computation of a node output during at least a portion of training. For example, noise may be introduced by perturbing one or more parameters, bounded parameters, coefficients, and/or node outputs. In some embodiments, coefficients may be derived from a bounded vector and used to evaluate a multilinear polynomial. In other embodiments, the trainable parameter vector may be used as the coefficients of the multilinear polynomial. A nonlinear bounding transformation may be applied to the result of evaluating the multilinear polynomial to produce the node output within a predetermined bounded interval.

In some embodiments, the multilinear polynomial representation can provide a differentiable training representation with reduced computational complexity (e.g., relative to a generic neural-network representation of the node). In some embodiments, coefficients are computed by applying a softmax operation to differentiable parameters and applying a linear transformation to the softmax result. In other embodiments, a nonlinear differentiable element-wise bounding function may be used. In some embodiments, a softmax normalization may be used. In some embodiments, a linear transformation may be applied to the resulting vector.

FIG. 5B illustrates an example process 500 for training a differentiable logic gate network using a reduced-parameter multilinear node representation and for discretizing the trained network to generate a fixed Boolean logic gate network. In some embodiments, process 500 includes maintaining, in the memory of a computing system, for each node in at least a subset of nodes, a trainable parameter vector of dimensionality p, where p is smaller than the total number of distinct k-input Boolean functions selectable by the node (step 510). For example, for a k-input node, the dimensionality p may be 2\hat{ }k, which is smaller than 2\hat{ }(2\hat{ }k), the total number of distinct k-input Boolean functions. In some embodiments, the trainable parameter vector is residually initialized such that a discretization rule initially selects a pass-through operator, an inverter operator, or another operator that functionally depends on only one non-constant input.

In some embodiments, process 500 further includes deriving, from the trainable parameter vector, coefficients for a k-input node function (step 520). In some embodiments, deriving the coefficients includes applying an element-wise nonlinear bounding transformation to the trainable parameter vector to obtain a bounded vector whose entries lie within a predetermined interval. In some embodiments, the step may optionally include applying a linear transformation to the bounded vector to obtain a coefficient vector. In some embodiments, the linear transformation is selected such that, for bounded vectors within the predetermined bounded interval, the resulting coefficients define a multilinear polynomial that maps inputs within [0,1]\hat{ }k to outputs within the predetermined bounded interval. In some embodiments, the nonlinear bounding transformation comprises a sigmoidal function.

In some embodiments, process 500 includes computing a node output from k input values by evaluating a multilinear polynomial using the coefficients (step 530). The node output may be generated within a predetermined bounded interval by applying a nonlinear bounding transformation to the result of evaluating the multilinear polynomial. In some embodiments, the coefficients are the trainable parameter vector itself or are derived from it via a linear (e.g., multilinear) transformation.

In some embodiments, process 500 further includes iteratively training the differentiable logic gate network over a plurality of training iterations (step 540). Each training iteration may include forward propagation through one or more nodes using the multilinear-polynomial representation. The training iterations may include computing a loss value based on one or more network outputs. The training iterations may also include updating at least one trainable parameter vector based on gradients of the loss value. After completing the iterative training, the computing system discretizes the differentiable logic gate network (step 550) by selecting, for each node in the subset, a single Boolean logic gate operator from a predefined finite set based on the trained parameter vector. Accordingly, the process generates a fixed Boolean logic gate network operable to perform inference using Boolean logic operations. In some embodiments, the fixed Boolean logic gate network is synthesized, technology-mapped, and deployed on physical digital hardware, such as an FPGA or ASIC.

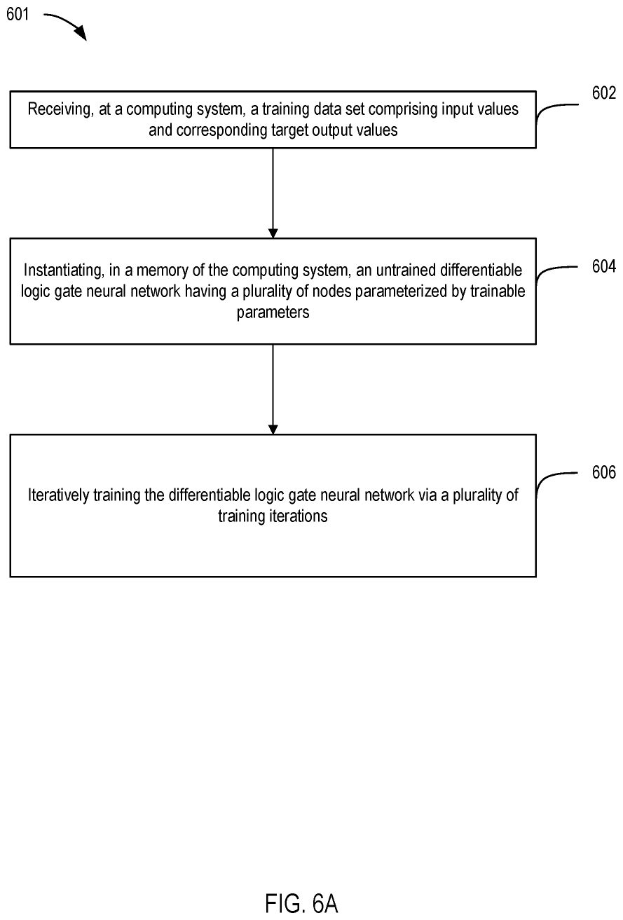

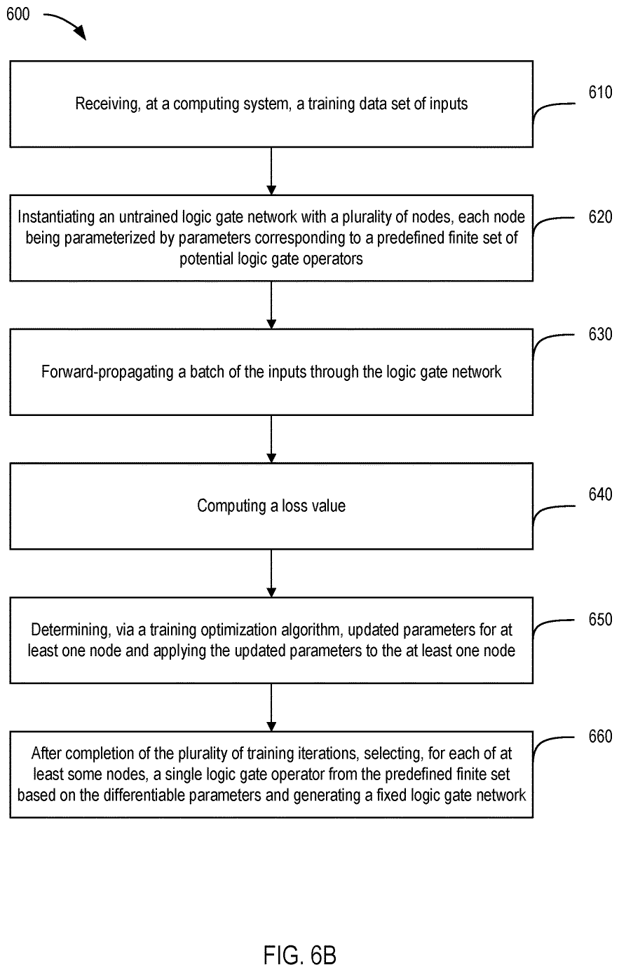

FIG. 6A illustrates an example process 601 for training a differentiable-logic-gate neural network. In some embodiments, process 601 includes receiving a training data set (step 602) including training inputs and corresponding target outputs. The computing system instantiates an untrained differentiable logic gate neural network (step 604), for example, by allocating nodes and initializing trainable parameters. The computing system iteratively trains the network (step 606) using a plurality of training iterations. Each training iteration may include forward-propagating a batch of training inputs through the network to produce at least one network output, computing a loss value that quantifies a difference between the network output and the target output, computing gradients of the loss via backpropagation, and updating trainable parameters using an optimization algorithm (e.g., gradient descent, Adam, RMSProp, or other optimizers).

In some embodiments, after training is complete (or at a selected time during training), the computing system generates a discretized network for inference. For example, one or more real-valued signals may be binarized, one or more differentiable operators may be replaced with corresponding discrete Boolean operators, and/or one or more hyper-logic gates may be configured to implement LUT selection based on binary-valued selector signals. In some embodiments, discretization includes selecting, for one or more nodes, a discrete operator instance from a predefined set, thereby generating a fixed logic gate network in which nodes provide hard binary outputs. In some embodiments, discretization includes selecting, for a hyper-logic gate, a single LUT entry (or LUT configuration) associated with a selector pattern. In some embodiments, the discretized network is compiled, synthesized, or mapped to hardware resources (e.g., FPGA LUTs and routing, ASIC standard cells, or other programmable-logic resources).

In some embodiments, the discretized or fixed logic gate network is represented as a truth table, Boolean expression, logic netlist, hardware description language (HDL) representation, configuration bitstream, and/or other data defining the fixed logic gate network. In some embodiments, one or more electronic design automation (EDA) tools may perform logic synthesis, optimization, technology mapping, placement, and/or routing of the fixed logic gate network. These tools and/or other tools may additionally be used to generate ASIC layout data and/or FPGA configuration data for the fixed logic gate network. In some embodiments, a hardware inference device comprises an ASIC implementing the fixed logic gate network. In other embodiments, a hardware inference device may comprise an FPGA with programmable logic fabric and configuration memory. The configuration memory may store instruction data and/or configuration data that configures the programmable logic fabric to implement the fixed logic gate network.

FIG. 6 illustrates an example process 600 for training a logic gate neural network and generating a fixed logic gate network. In some embodiments, process 600 includes receiving, at a computing system, a training data set of input vectors (step 610). The computing system instantiates, in memory, an untrained logic gate network with a plurality of nodes (step 620). Each node may be parameterized by a set of differentiable parameters corresponding to a predefined finite set of potential logic gate operators. In some embodiments, each node has a number of parameters equal to the number of potential logic gate operators in the respective predefined finite set. In other embodiments, each node has fewer parameters than the number of potential logic gate operators in the respective predefined finite set.

In some embodiments, process 600 includes iteratively training the logic gate network via a plurality of training iterations. During a given training iteration, the computing system forward-propagates a batch of input vectors through the logic gate network to generate a training network output (step 630). For each node, forward propagation may include computing a differentiable output that is a function of the node inputs and current differentiable parameters of the node. The differentiable output may be represented by a multilinear polynomial of the node inputs with differentiable coefficients based on the differentiable parameters. In some embodiments, the differentiable coefficients are computed by applying a softmax operation to the differentiable parameters and then applying a linear transformation to the result. In some embodiments, the differentiable coefficients are computed by applying a differentiable element-wise bounding function to the differentiable parameters, then applying a linear transformation to the result. In some embodiments, the differentiable coefficients are the differentiable parameter or are a linear transformation of the parameters.

In some embodiments, process 600 further includes computing a loss value (step 640), determining updated differentiable parameters for at least one node via a training optimization algorithm, and applying the updated differentiable parameters to the at least one node (step 650). The training optimization algorithm may determine the updated differentiable parameters by performing backpropagation through the logic gate network to compute the gradients or approximate gradients of the loss with respect to the differentiable parameters. The system may then use a gradient-descent based optimization algorithm to update the parameters. In some embodiments, groups of node outputs are aggregated via summation to obtain scores for use in computing the loss value. In some embodiments, three or more successive layers of nodes are trained before such summation and/or bit summation.

After completion of the plurality of training iterations, the computing system selects a single logic gate operator from the predefined finite set of potential logic gate operators based on the differentiable parameters of at least some of each respective node (step 660). Based on the selection, the computing system generates a fixed logic gate network in which the corresponding nodes implement the selected single logic gate operators. In some embodiments, the fixed logic gate network is subsequently implemented as logic circuitry in an application-specific integrated circuit (ASIC), configured in a field-programmable gate array (FPGA), or stored as data defining the fixed logic gate network.

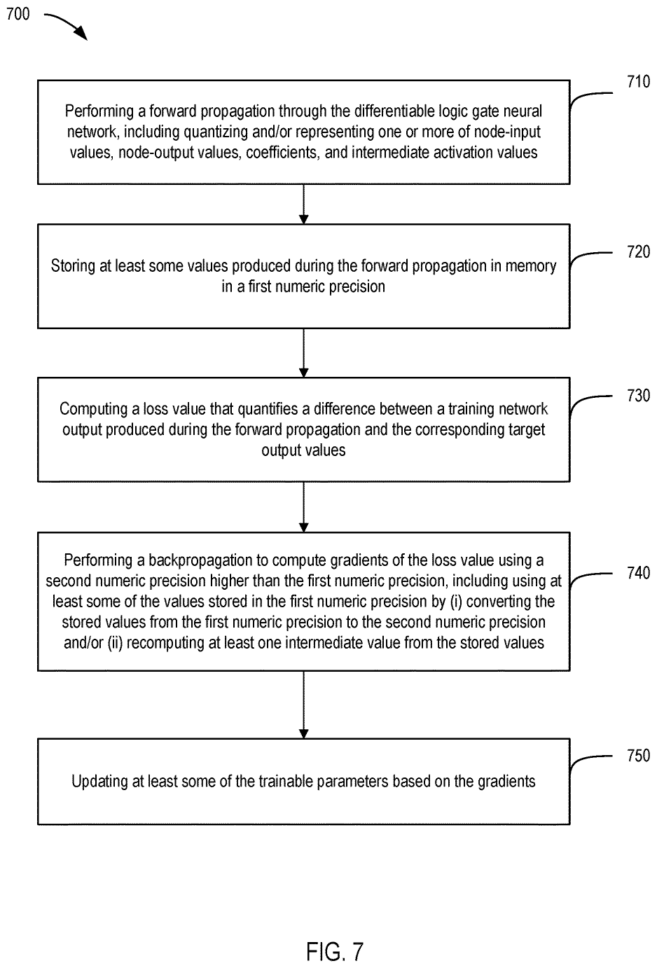

FIG. 7 illustrates an example process 700 in which forward propagation is performed through the differentiable logic gate neural network (step 710), at least some activation values produced during the forward propagation are stored in memory in a first numeric precision (step 720), a loss value is computed (step 730), backpropagation is performed to compute gradients using a second numeric precision higher than the first numeric precision (step 740), and at least some trainable parameters are updated based on the gradients (step 750). As described herein, a differentiable-logic-gate neural network may be trained using mixed-precision and/or asymmetric-precision techniques.

In some embodiments, during step 710, the computing system quantizes and/or represents one or more of node-input values, node-output values, coefficients, and intermediate activation values. In some embodiments, during step 720, the computing system stores at least some of these values in memory in a first numeric precision. The computing system computes a loss value (step 730) and then performs backpropagation using a second numeric precision (step 740). In some embodiments, during backpropagation, the computing system converts stored values from the first numeric precision to the second numeric precision prior to computing gradients.

In some embodiments, the computing system recomputes one or more intermediate values from stored values, rather than storing all intermediate values produced during forward propagation. For example, when a node computation is relatively inexpensive (e.g., evaluating a polynomial with a small coefficient vector), it may be more efficient to recompute intermediate activations than to store them at high precision. In some embodiments, storing at least some values produced during forward propagation includes storing only a subset of values needed for backpropagation and discarding other values. For example, the computing system may store node inputs to selected gates, discard intermediate values computed within a tree of gates, and then recompute them during backpropagation. In some embodiments, using mixed precision reduces memory bandwidth and/or memory usage during training and can improve overall training throughput.

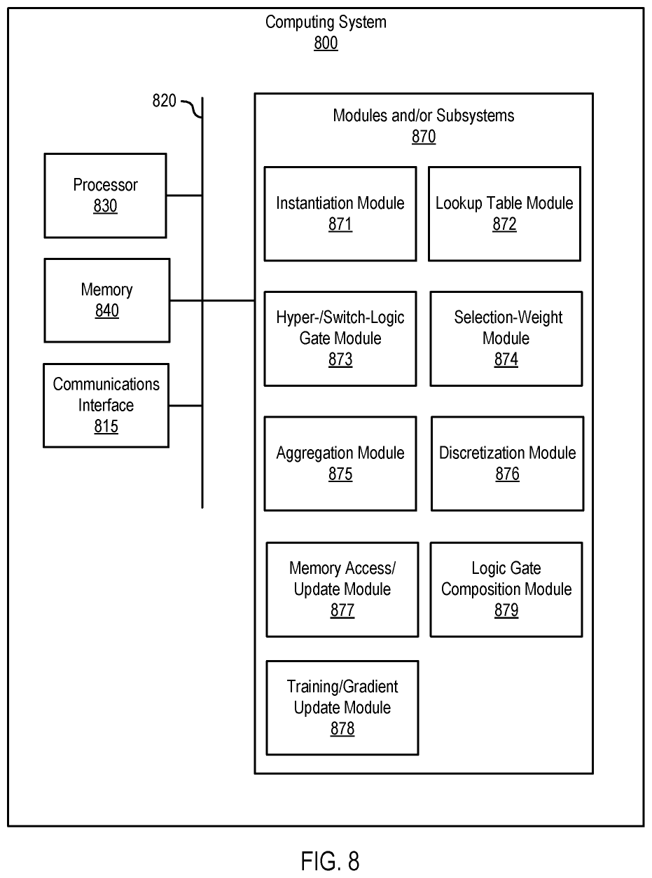

FIG. 8 illustrates an example computing system 800 architecture for implementing, training, and/or discretizing a logic gate neural network including one or more hyper-logic gate nodes, lookup-table type nodes, and/or switch-logic gate nodes, according to various embodiments. In the illustrated example, the computing system 800 includes at least one processor 830, memory 840, and a communications interface 815, which may be coupled via one or more buses 820. In some embodiments, the memory 840 stores instructions that, when executed by the processor 830, cause the computing system 800 to implement one or more of the techniques, methods, or processes described herein. For example, the computing system 800 may implement forward propagation through continuous and/or differentiable lookup-table type nodes, compute a loss, and/or update network parameters based on gradients, approximate gradients, sub-gradients, gradient estimates, and/or surrogate gradients.

In the illustrated embodiment, computing system 800 includes modules and/or subsystems 870, such as an instantiation module 871, a lookup table module 872, a hyper-/switch-logic gate module 873, a selection-weight module 874, an aggregation module 875, a discretization module 876, a memory access/update module 877, and a logic gate composition module 879. In various embodiments, some of the modules and/or subsystems 870 may be omitted and/or only partially implemented. For example, in a hyper-logic gate embodiment, the hyper-/switch-logic gate module 873 may be embodied as a hyper-logic gate module 873, as the “switch-logic gate” functions may not be relevant to such an embodiment. The modules and/or subsystems 870 may be implemented in software, hardware, and/or a combination thereof. For example, one or more modules may be implemented as instructions stored in memory 840 and executed by processor 830, and/or specialized circuitry including GPUs, TPUs, FPGAs, and/or ASICs.

In some embodiments, modules and/or subsystems 870 implement one or more hyper-logic gates, where each hyper-logic gate is configured as a differentiable lookup table that receives (i) a plurality of selector signals and (ii) a plurality of LUT entry signals and produces a hyper-logic gate output. In differentiable mode, the hyper-logic gate produces the hyper-logic gate output as a differentiable combination of the LUT entry signals, where combination weights are computed as differentiable functions of the selector signals to enable gradient-based training. In a discretized mode (e.g., after training), the hyper-logic gate may operate as a discrete lookup table and/or multiplexer in which binary-valued selector signals select a particular LUT entry signal to be provided as (or to determine) the hyper-logic gate output.

In some embodiments, the modules 870 implement one or more lookup-table-type computational nodes. For consistency with the various embodiments described herein, inputs to such nodes may be referred to as data inputs and configuration inputs, selector signals and LUT-entry signals, and/or selector inputs and a data input. For example, in a hyper-logic gate embodiment, k data inputs may serve as selector signals or indexing signals. The selector or indexing signals may be used to select among N configuration inputs. In a switch-logic gate embodiment, k selector inputs and one data input may be used to generate a plurality of output values corresponding to respective selector patterns. In continuous and/or differentiable embodiments, the nodes may operate on real-valued signals. In discretized mode embodiments, the nodes may operate on binary-valued signals and reduce to discrete lookup, multiplexing, switching, and/or Boolean logic behavior.

In some embodiments, instantiation module 871 instantiates a logic gate neural network that includes one or more hyper-logic gate nodes, one or more switch-logic gate nodes, and/or one or more differentiable logic-gate nodes. The instantiation module 871 may allocate node data structures in memory 840, initialize trainable parameters, configure connectivity among nodes (e.g., layer definitions, fan-in, and fan-out), and/or configure one or more nodes to operate as continuous lookup tables, differentiable lookup tables, discrete lookup tables, hyper-logic gates, switch-logic-gates, and/or other logic-gate-like computational nodes. In some embodiments, the instantiation module 871 configures a hyper-logic gate or lookup-table type node with k data inputs and N configuration inputs. The N configuration inputs may be equal to 2\hat{ }k, approximately 2\hat{ }k, or of the same order of magnitude as 2\hat{ }k.

In some embodiments, the instantiation module 871 configures the hyper-logic gate or lookup-table type node to operate with a selected number k of selector signals and a corresponding number (e.g., 2\hat{ }k) of LUT entry signals. In some embodiments, instantiation module 871 configures network features such as skip connections, residual connections, deep multilayer connections, and/or other non-sequential connections by providing outputs from non-adjacent nodes or layers as LUT entry signals to a hyper-logic gate or switch-logic gate. In some embodiments, one or more data inputs, configuration inputs, selector inputs, and/or data-input values are provided by learnable parameters, outputs of other computational nodes, network inputs, and/or values from an internal memory state. In some embodiments, some nodes may have no trainable parameters.

In some embodiments, lookup table module 872 implements a evaluation of a lookup-table type node. Examples of lookup-table type nodes include, but are not limited to, a continuous k-input lookup table and/or a differentiable k-input lookup table. In some embodiments, the lookup table module 872 may implement a differentiable LUT evaluation in which LUT entry signals represent candidate values to be selected and/or combined. For example, for k selector signals, the lookup table module 872 may evaluate a differentiable LUT having 2\hat{ }k LUT entry signals, where each LUT entry signal is associated with a respective selector pattern of the k selector signals. In some embodiments, one or more LUT entry signals are provided as (i) outputs of nodes from one or more previous layers, (ii) learnable parameters stored in memory 840, (iii) external inputs, and/or (iv) values read from an internal memory state. The lookup table module 872 may output a real-valued hyper-logic gate output that can be used as an input to subsequent nodes.

In some embodiments, a continuous k-input lookup table serves as a continuous relaxation of a discrete k-input lookup table. For example, lookup table module 872 may receive a plurality of real-valued input signals. Examples of real-valued input signals include data signals and configuration signals. The lookup table module may produce a real-valued node output by performing a continuous and/or differentiable selection among the configuration signals as a function of the data signals. In some embodiments, when the data inputs and configuration inputs are restricted to binary values, the node output equals the configuration input indexed by the binary values of the k data inputs. In some embodiments, one or more of the configuration inputs and/or data inputs may be provided by trainable parameters. In some embodiments, one or more of the configuration inputs and/or data inputs may be bounded to a range such as [0,1] or [−1,1] using a sigmoidal, hard-sigmoid, hyperbolic tangent, piecewise-linear saturating function, and/or another bounding function.

In some embodiments, a hyper-logic gate module or a switch-logic gate module, collectively labeled a hyper-/switch-logic gate module 873 configures and/or executes nodes as hyper-logic gates and/or switch-logic gates within the logic gate neural network. As a hyper-logic gate module 873, the module 873 may call selection-weight module 874 to compute differentiable selection weights from selector signals and may call aggregation module 875 to combine the selection weights with the LUT entry signals to produce a hyper-logic gate output. In some embodiments, hyper-logic gate module 873 configures a hyper-logic gate to operate as a differentiable logic gate by treating the LUT entry signals as a truth-table parameterization (e.g., one LUT entry per input pattern) and using one or more node inputs as the selector signals.

In a switch-logic-gate configuration, module 873 may instantiate a differentiable k-selector input switch having k selector inputs, one data input, and a plurality of output locations corresponding to respective selector patterns of the k selector inputs. Module 873 may compute a plurality of output values at the plurality of output locations as a continuous and/or differentiable function of the selector inputs and the data input. When the selector inputs are restricted to binary values, the output value at the output location indexed by the binary values of the selector inputs may equal the data input. In some embodiments, the output locations correspond to memory locations, registers, flip-flops, latches, or other state elements.

In some embodiments, the selection-weight module 874 computes continuous and/or differentiable selection weights for a plurality of selector patterns of the selector signals and/or output locations. For example, for a selector pattern b=(b₁, . . . , bₖ) in {0,1}\hat{ }k, LUT differentiable selection module 874 may form k terms tᵢ, where tᵢ=Sᵢ when bᵢ=1 and tᵢ=(1−Sᵢ) when bᵢ=0, and then combine the terms using a differentiable conjunction operator to produce a selection weight for the selector pattern b. Example conjunction operators include t-norms such as minimum, product, Einstein, Hamacher, Frank, Yager, Aczel-Alsina, Dombi, and Schweizer-Sklar t-norms. In some embodiments, the selection weights are computed such that, when selector signals are binary-valued, the selection weights are one-hot across selector patterns.

In some embodiments of a switch-logic-gate, a selection-weight module 874 may compute, for each output location, a respective selection weight and/or update degree by combining, using at least one conjunction operator, either a selector input or one minus the selector input for each of the k selector inputs according to the corresponding output location, and may combine the respective selection weight with the data input to generate the output value for that output location. In some embodiments, different nodes, or different logical operations within a single node, employ different relaxations, and the continuous and/or differentiable operations may be differentiable, differentiable almost everywhere, or paired with sub-gradient, gradient estimate, or surrogate-gradient training rules.

In some embodiments, aggregation module 875 aggregates values across selector patterns and/or output locations to produce a one or more node outputs (e.g., hyper-logic gate outputs). For example, aggregation module 875 may aggregate terms produced by selection-weight module 874 using summation, a continuous and/or differentiable disjunction operator, and/or a t-conorm. In some embodiments, when input signals are binary-valued, the selection weights become one-hot and the aggregation reduces to discrete lookup-table selection, multiplexer behavior, and/or discrete switching. In some embodiments, the aggregation module 875 also aggregates any number of outputs of one or more previous layers into fewer elements for use by a subsequent layer. In some embodiments, the aggregation module 875 implements a fully connected transformation prior to a group-sum operation by applying one-input gates (e.g., identity, negation, and/or parameterized unary operators) to form learned combinations of inputs, which are then fed to a subsequent aggregation stage.

In some embodiments, the discretization module 876 generates a discretized network for inference and/or for compilation to discrete logic. The discretization module 876 may discretize one or more real-valued signals (e.g., binarizing selector signals using thresholding) and/or replace one or more continuous or differentiable operators with corresponding discrete Boolean operators. In some embodiments, the discretization module 876 configures a hyper-logic gate to operate as a discrete lookup table and/or multiplexer such that, for binary-valued selector signals, a selected LUT entry signal is forwarded to produce the hyper-logic gate output. In some embodiments, a switch-logic-gate may be discretized such that binary-valued selector inputs cause the data input to appear at a selected output location. In some embodiments, the discretization module 876 outputs a discrete representation of a node, such as a truth table, a Boolean expression, or a logic-netlist representation suitable for implementation in hardware (e.g., FPGA and/or ASIC logic).

In some embodiments, memory access/update module 877 manages an internal memory state for the logic gate neural network. Memory access module 877 may provide read access in which selector signals specify (or are used to compute) an address of a memory location. Content stored at the addressed location may be provided as one or more LUT entry signals and/or as a hyper-logic gate output. Memory access module 877 may also provide write access, in which a switch-logic-gate and/or hyper-logic-gate writes to a selected memory location based at least in part on a data input or other write value. In some embodiments, the write value depends on a current memory content value, for example, by computing an updated value as a differentiable function of the write value and the current memory content value. In some embodiments, memory access module 877 implements differentiable writing by distributing a write operation across multiple memory locations using differentiable selection weights as write coefficients. In some embodiments, a state memory comprises a plurality of 2\hat{ }k memory locations, each associated with k selector inputs. Content stored in the memory location may be indexed by the selector inputs. The memory may be updated, at least in part, based on data input, hyper-logic gate output, and/or the current content of the memory location. In some embodiments, the internal memory state is stored in registers, flip-flops, and/or latches, for example. In some embodiments, writing is distributed across multiple memory locations using continuous and/or differentiable selection weights as write coefficients. In some embodiments, the memory state is updated from other internal wires or nodes including differentiable logic-gate node outputs, for example, for recurrence.

In some embodiments, logic gate composition module 879 constructs and/or executes compositions of hyper-logic gates and/or switch-logic gates, such as tree structures, hierarchical multiplexers, aggregation circuits, decision-logic circuits, etc. For example, logic gate composition module 879 may arrange hyper-logic gates in a tree structure in which an output of a first hyper-logic gate is provided as an LUT entry signal and/or selector signal to a second hyper-logic gate, thereby enabling hierarchical selection, hierarchical aggregation, and/or construction of larger effective lookup tables. In some embodiments, logic gate composition module 879 constructs a tree of hyper-logic gates to implement a larger multiplexer, structured pooling, and/or decision-logic circuits within the logic gate neural network.

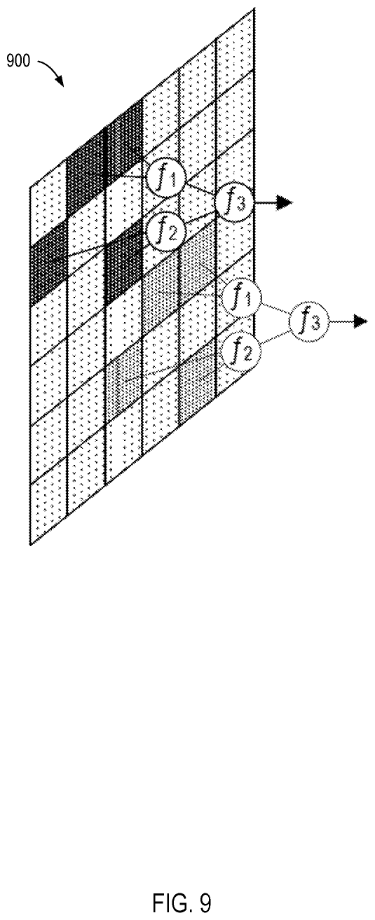

FIG. 9 illustrates an example diagram 900 in which outputs (e.g., feature-map values) from a larger set of nodes may be aggregated or pooled for use by a subsequent node or layer. In some embodiments, hyper-logic gates are arranged in a tree structure (or other composition structure). For example, the output of a first hyper-logic gate may be provided as an LUT entry signal to a second hyper-logic gate, enabling hierarchical selection and/or hierarchical aggregation. Such tree structures may be used to build larger multiplexers, to implement structured pooling operations, and/or to implement structured decision logic.

Use cases for hyper-logic gates include, but are not limited to: (i) aggregating outputs of previous layers into fewer elements; (ii) switching or multiplexing among signals by using selector signals to configure selection among LUT entry signals; (iii) implementing a differentiable logic gate by configuring LUT entry signals to represent a truth table; (iv) accessing a specific location from an internal memory state; (v) writing to a memory location, optionally depending on current memory content; (vi) implementing skip connections; (vii) creating a fully connected layer prior to a group-sum operation using one-input gates; (viii) serving as a building block in a tree of hyper-logic gates within a logic gate neural network; and (ix) implementing differentiable selection using alternative t-norms and t-conorms.

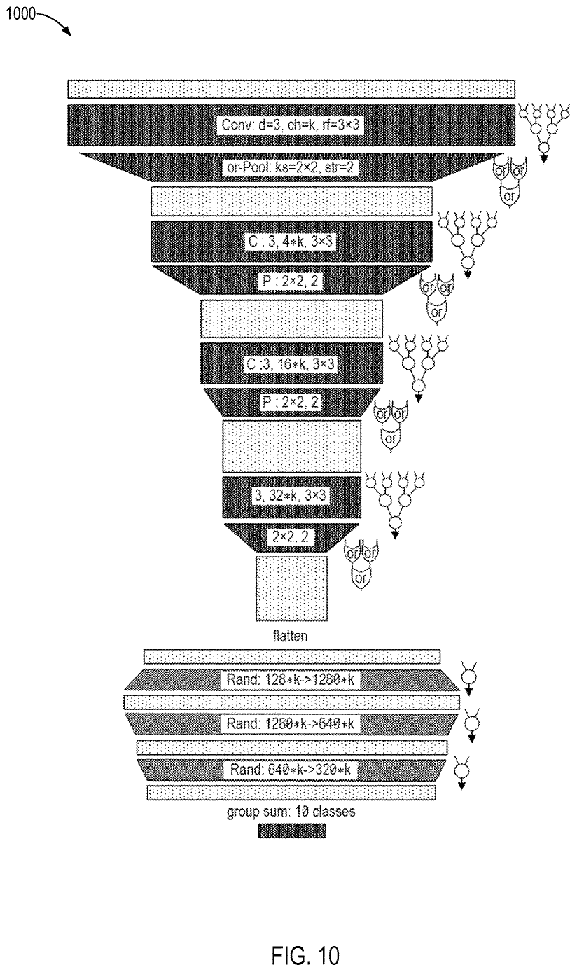

FIG. 10 illustrates an example convolutional logic gate network architecture 1000 (also referred to herein as a LogicTreeNet architecture) that is configured to perform an inference task (e.g., image classification) using logic-gate-based computation. In various embodiments, the architecture 1000 includes a plurality of convolutional logic-gate-tree blocks (“Conv” blocks) and corresponding pooling blocks, followed by a classification head comprising one or more randomly connected differentiable logic layers (“Rand” layers) and a GroupSum output stage. In some embodiments, the architecture 1000 follows a pattern similar to conventional convolutional architectures by applying convolutional blocks with pooling at the end of each block, where each block reduces spatial resolution (e.g., by a factor of 2×2) while increasing the number of channels, until a target spatial resolution (e.g., 2×2) is reached. Thereafter, the architecture 1000 applies a classification head and produces class scores (or other outputs) using a group aggregation operation.

In the illustrated example, the architecture 1000 is defined by a hyperparameter k that controls the network width (e.g., the number of kernels and/or channels across one or more stages). In some embodiments, k may be selected from a set of discrete model scales (e.g., S, M, B, L, G) that correspond to different width values, such that smaller k values yield smaller, faster models, and larger k values yield larger, more accurate models.

Each Conv block of FIG. 10 is configured to perform a convolution-like operation in which an input activation tensor is convolved with one or more learnable logic gate trees, thereby producing one or more output channels. In various embodiments, each convolution kernel is implemented as a logic-gate tree (e.g., a complete binary tree) of depth d, where the internal nodes of the tree comprise logic-gate operators and the leaves are selected from the receptive field of the input activation tensor. For example, in some embodiments, a kernel with depth d comprises (2\hat{ }d−1) internal logic-gate nodes and receives 2\hat{ }d leaf inputs from the receptive field, thereby computing a tree-structured composition of logic operations.

In some embodiments, leaf inputs to each logic gate tree are selected from a predefined receptive field of a size and across one or more input channels. In some embodiments, the selection of leaf inputs is determined by one or more connection-index tensors that specify: (i) which input channel is selected for each leaf input and (ii) a spatial offset within the receptive field for each leaf input. In some embodiments, the connection indices are randomly initialized (e.g., pseudo-randomly) and may remain fixed during training while the logic-gate operator choices in the tree are learned.

As illustrated, the Conv blocks may use a receptive field size of 3×3 (“rf=3×3”) and a tree depth of d=3 (e.g., “Conv: d=3, ch=k, rf=3×3” for the first block), although other receptive field sizes and tree depths may be used. In some embodiments, each output channel corresponds to a distinct tree kernel, and the set of tree kernels in a block defines the number of output channels for that block. In the illustrated example architecture 1000, the first Conv block uses k kernels (channels), the second uses 4k kernels, the third uses 16k kernels, and the fourth uses 32k kernels.

In various embodiments, convolutional parameter sharing is achieved by reusing the same kernel (i.e., the same learnable operator-parameterizations of the tree nodes) across multiple spatial placements (i.e., across different (i, j) locations), similar to how CNN weights are shared across spatial locations. In some embodiments, for each output channel (tree kernel), the logic gates (or their differentiable/relaxed forms) are chosen and parameterized independently, but all placements of that kernel share those parameters.

FIG. 10 further illustrates pooling blocks coupled after one or more Conv blocks. In various embodiments, the pooling blocks are configured to perform a logical pooling operation over receptive fields, such as a logical OR pooling operation that aggregates activations within a pooling receptive field. In some embodiments, pooling may be implemented as a relaxed Boolean aggregation using a t-conorm or t-norm formulation; for example, logical OR pooling may be implemented using a maximum t-conorm relaxation such that, for a pooling receptive field, the pooled activation equals the maximum activation within the receptive field (i.e., max pooling as an OR relaxation).

In some embodiments, the pooling operation is configured as strided pooling, in which the stride equals the size of the pooling receptive field (e.g., a 2×2 kernel with a stride of 2), thereby defining non-overlapping pooling regions. This configuration provides computational and memory advantages: the system may store only the pooled activation and a selection index (or other selection data) indicating which activation was selected as the maximum, and during training, it may backpropagate gradients only through the selected activation(s).

In the illustrated example, each pooling block is shown with a pooling kernel size of 2×2 and a stride of 2 (e.g., “or-Pool: ks=2×2, str=2” for the first pooling block, and “P: 2×2, 2” for subsequent pooling blocks). Consistent with the above, in some embodiments, each pooling block performs logical OR pooling with a kernel size of 2×2 and a stride of 2. In one illustrative embodiment for an image-classification task (e.g., CIFAR-10), FIG. 10 shows an architecture 1000 comprising four convolutional blocks, followed by three randomly connected logic layers and a GroupSum output stage.

In some embodiments, the Conv blocks and Rand layers comprise learnable (differentiable) logic-gate nodes, while the pooling layers are fixed (non-learnable) logical aggregation layers. In some embodiments, during training, the learnable logic-gate nodes are implemented as probabilistic (or other differentiable) relaxations of logic gates, where each learnable node is parameterized by a softmax distribution over a set of candidate logic operators, and the node output is computed from the learned distribution. In contrast, in some embodiments, the pooling layers are implemented using fixed logical OR operations (or their continuous max t-conorm relaxations) rather than learned gate choices.

In some embodiments, training of the architecture 1000 is implemented using fused compute kernels that fuse evaluation of a logic gate tree (per kernel placement) together with pooling, thereby reducing memory traffic. For example, in an embodiment with tree depth d=3 and 2×2 OR pooling, the system may evaluate four tree placements corresponding to a 2×2 pooling region, then apply a maximum t-conorm pooling operation to produce a single pooled output. In such embodiments, intermediate values (e.g., intermediate tree node outputs and/or intermediate pre-pooling outputs) may be held in registers or local storage and need not be written to memory, and the system may write only the pooled output value and an index of the pooling operation to memory, thereby reducing memory writes and overall training memory footprint. During a backward pass, the system may recompute only selected intermediate values corresponding to the selected pooling path, as needed, to propagate gradients.

In some embodiments, after the convolutional and pooling stages, the architecture 1000 includes a classification head comprising multiple regular, differentiable logic layers (Rand layers) followed by a GroupSum stage. In some embodiments, the Rand layers are “arbitrarily connected” layers in which connectivity between nodes may be arbitrarily constructed and maintained, while the per-node operator choices are learned. In the context of “arbitrarily connected” layers, the connected layers of nodes are used as the basis for training a variety of connections and/or connection patterns. The “arbitrarily connected” layers may also be referred to as “randomly connected.” In various embodiments, the connections may be updated during training. In some embodiments, the GroupSum stage partitions output nodes into groups (e.g., 10 groups corresponding to 10 classes) and computes, for each group, a class score by aggregating (e.g., summing) the outputs of nodes in that group. In some embodiments, the resulting class scores may be used to compute a prediction (e.g., via an argmax over class scores). In hardware-oriented embodiments, the aggregation may be implemented using adders realized as logic gates to efficiently accumulate output bits into an integer score per class.

In some embodiments, training uses an optimizer that maintains a moving average and/or an estimator of gradient variances, such as Adam. In some embodiments, a GroupSum stage produces class scores that are divided by a temperature parameter before being used as logits in a softmax cross-entropy loss. In some embodiments, the neural network comprises at least one million computational nodes and/or at least one million hyper-logic gates. In some embodiments, activation values and/or configuration input values are stored as uint8 values representing scaled values in [0,1]. Evaluation of a hyper-logic gate accesses may be, in some embodiments, at most (k+2\hat{ }k)×8 bits per evaluation (e.g., when the k data inputs and 2\hat{ }k configuration inputs are each represented using 8 bits). In some embodiments, a fixed logic gate network implemented in hardware performs inference with a latency of less than 250 nanoseconds.

Although FIG. 10 illustrates a particular example architecture 1000, the illustrated configuration is non-limiting. For example, in various embodiments: (i) the number of convolutional blocks may be greater than or less than four; (ii) receptive field sizes may differ across blocks (e.g., 5×5 in an initial block for certain datasets); (iii) tree depth d may vary by block; (iv) pooling may be applied at some blocks but not others; (v) pooling may be OR pooling (max t-conorm), AND pooling (min t-norm), or a mixture; and/or (vi) the classification head may include additional or fewer Rand layers, different layer widths, and/or different output aggregation strategies.

In some embodiments, a logic gate neural network and/or a fixed logic gate network obtained by discretizing the logic gate neural network comprises at least ten successive layers of computational nodes, at least twenty successive layers of computational nodes, or more. In some embodiments, at least one hyper-logic gate is present in each of at least ten successive layers. In some embodiments, hyper-logic gates may be present in at least 25% of at least twenty successive layers. Outputs of computational nodes in a first subset of layers may be provided as configuration inputs to one or more hyper-logic gates in a second subset of layers. In some embodiments, one or more skip connections may connect non-adjacent layers. In some embodiments, a network may comprise multiple computational nodes that comprise hyper-logic gates. In such embodiments, some of the hyper-logic gates may be, during logic synthesis of the discretized network, omitted from the synthesized neural network and/or simplified.

Additionally, in some embodiments, one or more connectivity restrictions may be applied for convolutional tree inputs to improve performance and/or hardware routing; for example, selection of input channels (CM) for each tree may be restricted such that each tree observes only a limited number of channels (e.g., two channels) to enforce spatial comparisons within a channel and/or to reduce routing congestion in hardware implementations, although such restrictions are optional and the method is not limited thereto.

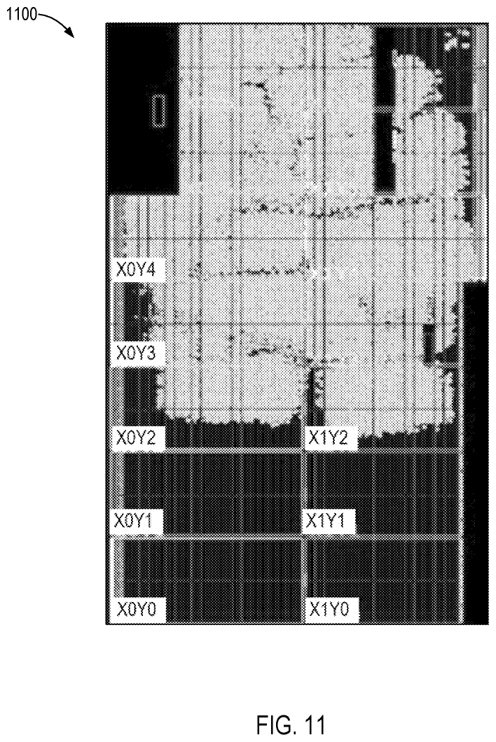

FIG. 11 illustrates an example hardware placement 1100 of a trained logic gate network on a programmable logic device. In some embodiments, after training and discretization, logic-gate nodes and/or hyper-logic gates may be synthesized into hardware, including LUTs, logic elements, and routing resources. The ability to express nodes as LUT selection (e.g., in discretized mode) can facilitate implementation on FPGA architectures and other digital-logic substrates. In some embodiments, to facilitate routable placement and reduce routing congestion, the system may select and/or constrain internal connections of the logic-gate network that are recombined at a stage of output-gate accumulation (akin to grouped convolution), while maintaining accuracy given the inherent sparsity of logic-gate networks.

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, mathematical representations, combinations, and permutations of features, optional components, optional steps, and optional methods may be adapted for a specific environment and/or operating requirements without departing from the principles and scope of this disclosure. These and other changes or modifications, and all possible permutations and combinations of examples and embodiments disclosed, are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described with regard to various embodiments. However, benefits, advantages, solutions to problems, and any element(s) that may cause any benefit, advantage, or solution to occur or become more pronounced are not to be construed as a critical, required, or essential feature or element. Indeed, even inferior or non-optimized versions of the described embodiments are intended to be included within the scope of this disclosure. The scope of this disclosure includes the numbered claims below, including all feasible combinations thereof.

What is claimed is:

1. A computing system, comprising:
at least one processor; and
a memory storing instructions that, when executed by the at least one processor, cause the computing system to perform training of a logic gate neural network, the logic gate neural network comprising a plurality of interconnected nodes, wherein at least one node comprises a continuous lookup table (LUT) configured to operate as a hyper-logic gate to:
receive a plurality of real-valued input signals, including data signals and configuration signals, and
produce a real-valued hyper-logic gate output by performing a continuous selection among the configuration signals as a function of the data signals.

2. A computer-implemented method for training a neural network, comprising:
providing a neural network comprising a plurality of computational nodes, wherein at least one computational node comprises a hyper-logic gate, and wherein the hyper-logic gate, during training, is realized by a differentiable k-input lookup table, where k is an integer greater than or equal to 1, the differentiable k-input lookup table having:
(i) k data inputs, each receiving a real value; and
(ii) N configuration inputs, where N is an integer greater than k, each configuration input receiving a real value;
computing an output of the at least one computational node as a differentiable function of the k data inputs and the N configuration inputs, wherein, when the k data inputs and the N configuration inputs are restricted to binary values, the output equals the configuration input indexed by the binary values of the k data inputs, wherein at least one of the N configuration inputs is provided by an output of one of the computational nodes in the neural network;
computing a loss from outputs of the neural network;
updating parameters of the neural network based on gradients or approximate gradients of the loss propagated through the differentiable k-input lookup table; and
discretizing the neural network, after training, such that the inputs to the hyper-logic gate are binary values, and the output of the hyper-logic gate equals the configuration input indexed by the binary values of the k data inputs.

3. The method of claim 2, wherein the number of configuration inputs, N, is 2\hat{ }k.

4. The method of claim 3, further comprising, after training, discretizing the neural network produces a fixed logic gate network, wherein the differentiable k-input lookup table is reduced to a Boolean k-input lookup table by virtue of all inputs thereto assuming binary values.

5. The method of claim 4, further comprising:
implementing a logical expression of the fixed logic gate network in a field-programmable gate array (FPGA) for subsequent use with other inputs.

6. The method of claim 4, further comprising:
implementing a logical expression of the fixed logic gate network as an application-specific integrated circuit (ASIC) for subsequent use with other inputs.

7. The method of claim 4, wherein the fixed logic gate network is represented in a hardware description language.

8. The method of claim 3, further comprising, after training, discretizing the neural network to produce a fixed logic gate network, wherein the differentiable k-input lookup tables is mapped to a multiplexer gate by virtue of all inputs thereto assuming binary values.

9. The method of claim 3, wherein, after discretizing, at least one hyper-logic gate operates as a multiplexer circuit wherein the k data inputs select which of the 2\hat{ }k configuration inputs is passed to the output.

10. The method of claim 3, wherein computing the output comprises: for each of the k data inputs, forming a complementary pair comprising the data input value and one minus the data input value; forming 2\hat{ }k terms, each term computed by applying a differentiable approximation of logical conjunction to a respective configuration input and one element selected from each of the k complementary pairs; and aggregating the 2\hat{ }k terms using a differentiable approximation of logical disjunction.

11. The method of claim 2, wherein the hyper-logic gate comprises an aggregation comprising at least one of: summation, a differentiable disjunction operator, and a t-conorm.

12. The method of claim 2, wherein, when the k data inputs are restricted to binary values, the output equals the configuration input indexed by the binary values of the k data inputs.

13. The method of claim 3, wherein at least one of the 2\hat{ }k configuration inputs or k data inputs is provided by an internal memory state stored in a register or flip-flop.

14. The method of claim 13, wherein all 2\hat{ }k configuration inputs to at least one hyper-logic gate are provided by internal memory values stored in registers or flip-flops.

15. The method of claim 13, wherein all k data inputs to at least one hyper-logic gate are provided by internal memory values stored in registers or flip-flops.

16. The method of claim 3, wherein k is greater than or equal to 2.

17. The method of claim 3, wherein at least ten computational nodes each comprise a hyper-logic gate, the method further comprising:
generating, after training, a fixed logic gate network from the neural network, comprising:
performing logic synthesis, wherein, during the logic synthesis, at least five computational nodes that comprised a hyper-logic gate are omitted or simplified.

18. The method of claim 3, further comprising, after training:
discretizing the neural network produces a fixed logic gate network, wherein the differentiable k-input lookup table is reduced to a Boolean k-input lookup table by virtue of all inputs thereto assuming binary values,
wherein, when the k data inputs are restricted to binary values, the output equals the configuration input indexed by the binary values of the k data inputs,
wherein k is greater than or equal to 2,
wherein at least ten computational nodes each comprise a hyper-logic gate, the method further comprising:
generating, after training, a fixed logic gate network from the neural network, including performing logic synthesis, during which at least five computational nodes that comprised a hyper-logic gate are omitted or simplified.

19. The method of claim 3, wherein k data inputs of a first hyper-logic gate are provided by outputs of other computational nodes in the neural network, and 2\hat{ }k configuration inputs of the first hyper-logic gate are provided by outputs of other computational nodes in the neural network, such that all k+2\hat{ }k inputs to the first hyper-logic gate are dynamic signals.

20. The method of claim 3, wherein the neural network comprises at least ten successive layers of computational nodes.

21. The method of claim 3, wherein the neural network further comprises an internal memory state comprising a plurality of memory locations, wherein the hyper-logic gate is configured to access a selected memory location as a function of the k data inputs and to produce the hyper-logic gate output based at least in part on content stored in the selected memory location.

22. The method of claim 3, wherein the hyper-logic gate is configured to implement a skip connection by receiving, as at least one of the configuration inputs, an output of a node that is not in an immediately preceding layer of the neural network, and the hyper-logic gate selecting or combining the configuration inputs and data inputs such that the hyper-logic gate output provides information from the node that is not in the immediately preceding layer.

23. The method of claim 3, wherein the hyper-logic gate is configured to aggregate a larger number of outputs of one or more previous layers into fewer elements by receiving, as at least some of each the data inputs and configuration inputs, respective computational node outputs generated in the one or more previous layers and producing the hyper-logic gate output for use by a subsequent layer.

24. The method of claim 3, wherein a plurality of the computational nodes comprises hyper-logic gates arranged in a tree structure, wherein a hyper-logic gate output of at least one hyper-logic gate in the tree is provided as at least one of the configuration inputs to a distinct hyper-logic gate in the tree.

25. The method of claim 3, wherein the neural network is a differentiable logic gate network.

26. The method of claim 25, the neural network further comprising at least one computational node comprising a trainable logic node parameterized by a set of differentiable parameters corresponding to a predefined set of potential logic gate operators,
wherein forward-propagating through the trainable logic node comprises computing a differentiable output that is a function of the outputs of the potential logic gate operators of the respective node according to current differentiable parameters thereof, and
wherein the discretizing further comprises, for each of at least a subset of the trainable nodes, selecting a single logic gate from the set of potential logic gate operators for a plurality of the nodes based on the differentiable parameters thereof.

27. The method of claim 26, wherein the predefined set of potential logic gate operators includes at least two elements, including one or more of: an AND operator, an OR operator, a NAND operator, a NOR operator, an XOR operator, a constant TRUE operator, a constant FALSE operator, an inverter operator, and a pass-through operator that outputs one of the node inputs.

28. The method of claim 3, wherein initializing the neural network comprises residual initialization, wherein the parameters of the neural network are initialized such that, upon discretization of an initialized model, a majority of computational nodes passes through exactly one input signal unchanged or inverted.

29. The method of claim 3, wherein the neural network comprises at least one million computational nodes.

30. An application-specific integrated circuit (ASIC), comprising:
logic circuitry implementing a fixed logic gate network,
wherein the fixed logic gate network is generated by a process comprising:
providing a neural network comprising a plurality of computational nodes, wherein at least one computational node comprises a hyper-logic gate, and wherein the hyper-logic gate, during training, is realized by a differentiable k-input lookup table, k≥1, the differentiable k-input lookup table having:
(i) k data inputs, each receiving a real value; and
(ii) N configuration inputs, where N is an integer greater than k, each configuration input receiving a real value;
computing an output of the at least one computational node as a differentiable function of the k data inputs and the N configuration inputs, wherein, when the k data inputs and the N configuration inputs are restricted to binary values, the output equals the configuration input indexed by the binary values of the k data inputs, and wherein at least one of the N configuration inputs is provided by an output of one of the plurality of computational nodes in the neural network;
computing a loss from outputs of the neural network;
updating parameters of the neural network based on gradients or approximate gradients of the loss propagated through the differentiable k-input lookup table; and
discretizing the neural network, after training, to produce the fixed logic gate network such that inputs to the hyper-logic gate are binary values and the output of the hyper-logic gate equals the configuration input indexed by the binary values of the k data inputs.
